(19) United States
(12) Patent Application Publication
(10) Pub. No.: US 2016/0371241 A1
(43) Pub. Date: Dec. 22, 2016

(54) AUTOCREATE FILES USING CUSTOMIZABLE LIST OF STORAGE LOCATIONS

(71) Applicant: Microsoft Technology Licensing, LLC, Redmond, WA (US)

(72) Inventors: Candy H.M. Wong, Cambridge, MA (US); Manoj Sharma, Winchester, MA (US)

(73) Assignee: Microsoft Technology Licensing, LLC, Redmond, WA (US)

(21) Appl. No.: 14/744,807

(22) Filed: Jun. 19, 2015

(51) Int. Cl. G06F 17/24; G06F 3/0482

(52) U.S. Cl. CPC G06F 17/24; G06F 3/0482

(57) ABSTRACT

Aspects of the present disclosure relate to systems and methods for creating at least one file associated with an application using a customizable list of storage locations. The customizable list of storage locations may be generated based on one or more parameters associated with the application. A selection of a file command for creating the at least one file associated with the application may be received within the application. A trigger associated with the at least one file may be detected. The at least one file may be automatically created to a storage location from the customizable list of storage locations in response to detecting the trigger associated with the at least one file.

### BACKGROUND

Files associated with applications such as word processing applications, spreadsheet applications, electronic slide presentation applications, email applications, chat applications, voice applications, and the like, may be created to local storage on a device and/or to a server location (e.g., cloud storage). Current file creation techniques require a manual selection of a “save as” option, for example, or an auto-creation of the file to one proprietary server storage location. For example, when a file is saved locally on a device or to a server location, a user is required to select a save location, provide a file name, and confirm an action before a permanent file is created. In another example, a cloud storage provider may have a default and/or proprietary storage location where a file may be auto-created and/or stored. In this regard, a user has to either manually or explicitly create/save a file to a location or the file is auto-created to one proprietary location that is not chosen by the user. Accordingly, current file creation techniques can be inefficient, insecure, and may lack transparency.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In summary, the disclosure generally relates to systems and methods for creating at least one file associated with an application using a customizable list of storage locations. In aspects, the customizable list of storage locations may be generated based on one or more parameters associated with the application. The customizable list of storage locations may be displayed within the application. A selection of a file command for creating the at least one file associated with the application may be received within the application. A trigger associated with the at least one file may be detected. The at least one file may be automatically created to a storage location from the customizable list of storage locations in response to detecting the trigger associated with the at least one file.

### DESCRIPTION OF THE DRAWINGS

The detailed description is described with reference to the accompanying figures. In the figures, the left-most digit(s) of a reference number identifies the figure in which the reference number first appears. The use of the same reference numbers in different instances in the description and the figures may indicate similar or identical items.

FIG. 1 is illustrates an exemplary system for creating at least one file associated with an application using a customizable list of storage locations, according to an example aspect.

FIG. 2 illustrates an exemplary touchable user interface for creating at least one file associated with an application using a customizable list of storage locations, according to an example aspect.

FIG. 3 illustrates an exemplary touchable user interface for creating at least one file associated with an application using a customizable list of storage locations, according to an example aspect.

FIG. 4 illustrates an exemplary method for creating at least one file associated with an application using a customizable list of storage locations, according to an example aspect.

FIG. 5 illustrates an exemplary method for providing a customizable list of storage locations, according to an example aspect.

FIG. 6 is a block diagram illustrating example physical components of a computing device with which aspects of the disclosure may be practiced.

FIGS. 7A and 7B are simplified block diagrams of a mobile computing device with which aspects of the present disclosure may be practiced.

FIG. 8 is a simplified block diagram of a distributed computing system in which aspects of the present disclosure may be practiced.

FIG. 9 illustrates a tablet computing device for executing one or more aspects of the present disclosure.

### DETAILED DESCRIPTION

Aspects of the disclosure are directed to creating at least one file associated with an application using a customizable list of storage locations. In one example, the customizable list of storage locations may be generated based one or more parameters. In another example, the at least one file may be automatically created to a storage location from the customizable list of storage locations in response to detecting a trigger associated with the at least one file. As discussed above, current file creation techniques require a manual selection of a “save as” option, for example, or an auto-creation of the file to one proprietary server storage location. For example, when a file is saved locally on a device or to a server location, a user is required to select a save location, provide a file name, and confirm an action before a permanent file is created. In another example, a cloud storage provider may have a default and/or proprietary storage location where a file may be auto-created and/or stored. In this regard, a user has to either manually or explicitly create/save a file to a location or the file is auto-created to one proprietary location that is not chosen by the user. Accordingly, current file creation techniques can be inefficient, insecure, and may lack transparency. Accordingly, aspects described herein include a system for automatically creating at least one file associated with an application using a customizable list of storage locations. In aspects, the system provides a customizable list of storage locations. In turn, the system improves user efficiency, storage and/or process security, user interaction performance, and storage transparency when creating files associated with applications.

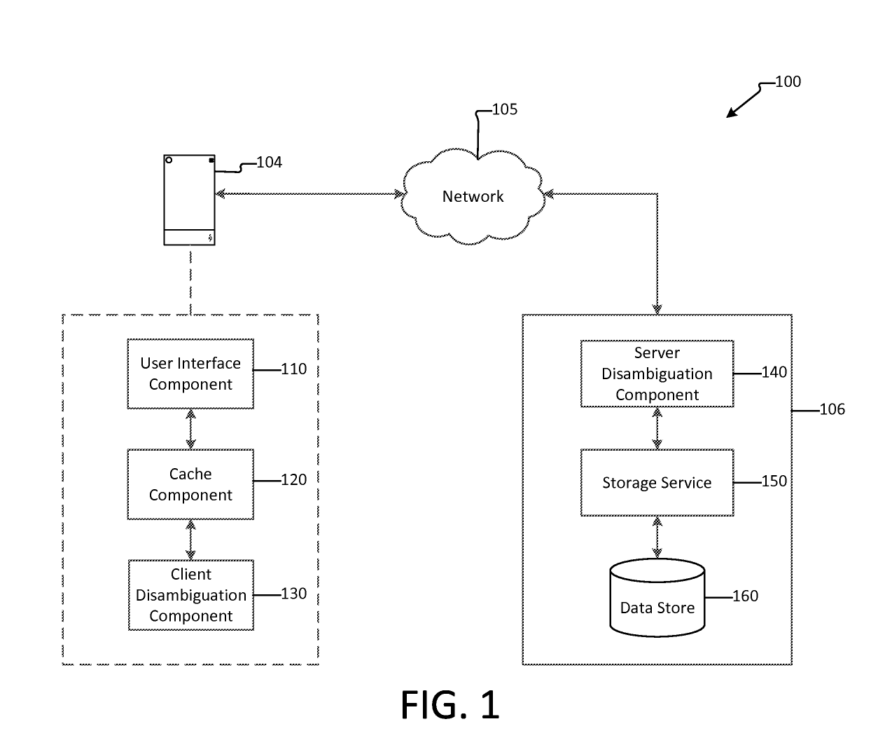

Referring now to the drawings, in which like numerals represent like elements through the several figures, aspects of the present disclosure and the exemplary operating environment will be described. With reference to FIG. 1, one aspect of a system 100 for creating at least one file associated with an application using a customizable list of storage locations is illustrated. In aspects, the system 100 may be implemented on a client computing device 104. In a basic configuration, the client computing device 104 is a handheld computer having both input elements and output elements. The client computing device 104 may be any suitable computing device for implementing the system 100 for creating at least one file associated with an application using a customizable list of storage locations. For example, the client computing device 104 may be at least one of: a mobile telephone; a smart phone; a tablet; a phablet; a smart watch; a wearable computer; a personal computer; a desktop computer; a laptop computer; a gaming device/computer (e.g., Xbox); a television; and etc. This list is exemplary only and should not be considered as limiting. Any suitable client computing device 104 for implementing the system 100 for creating at least one file associated with an application using a customizable list of storage locations may be utilized.

In aspects, the system 100 may be implemented on a server computing device 106. The server computing device 106 may provide data to and from the client computing device 104 through a network 105. In aspects, the system 100 may be implemented on more than one server computing device 106, such as a plurality of server computing devices 106. As discussed above, the server computing device 106 may provide data to and from the client computing device 104 through the network 105. The data may be communicated over any network suitable to transmit data. In some aspects, the network is a distributed computer network such as the Internet. In this regard, the network may include a Local Area Network (LAN), a Wide Area Network (WAN), the Internet, wireless and wired transmission mediums. In this regard, at least one file associated with an application may be created using a customizable list of storage locations by the system 100.

The aspects and functionalities described herein may operate via a multitude of computing systems including, without limitation, desktop computer systems, wired and wireless computing systems, mobile computing systems (e.g., mobile telephones, netbooks, tablet or slate type computers, notebook computers, and laptop computers), hand-held devices, multiprocessor systems, microprocessor-based or programmable consumer electronics, minicomputers, and mainframe computers.

In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an Intranet. User interfaces and information of various types may be displayed via on-board computing device displays or via remote display units associated with one or more computing devices. For example, user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

As illustrated in FIG. 1, the system 100 may include a user interface component 110, a cache component 120, a client disambiguation component 130, a server disambiguation component 140, a storage service 150, and a data store 160. The various components may be implemented using hardware, software, or a combination of hardware and software. The system 100 may be configured to create at least one file associated with an application using a customizable list of storage locations. In this regard, the user interface component 110 may be configured to display a customizable list of storage locations for creating and storing at least one file associated with an application. In one example, the user interface component 110 may be a touchable user interface that is capable of receiving input via contact with a screen of the client computing device 104, thereby functioning as both an input device and an output device. For example, content may be displayed, or output, on the screen of the client computing device 104 and input may be received by contacting the screen using a stylus or by direct physical contact of a user, e.g., touching the screen. Contact may include, for instance, tapping the screen, using gestures such as swiping or pinching the screen, sketching on the screen, etc.

In another example, the user interface component 110 may be a non-touch user interface. In one case, a tablet device, for example, may be utilized as a non-touch device when it is docked at a docking station (e.g., the tablet device may include a non-touch user interface). In another case, a desktop computer may include a non-touch user interface. In this example, the non-touchable user interface may be capable of receiving input via contact with a screen of the client computing device 104, thereby functioning as both an input device and an output device. For example, content may be displayed, or output, on the screen of the client computing device 104 and input may be received by contacting the screen using a cursor, for example. In this regard, contact may include, for example, placing a cursor on the non-touchable user interface using a device such as a mouse.

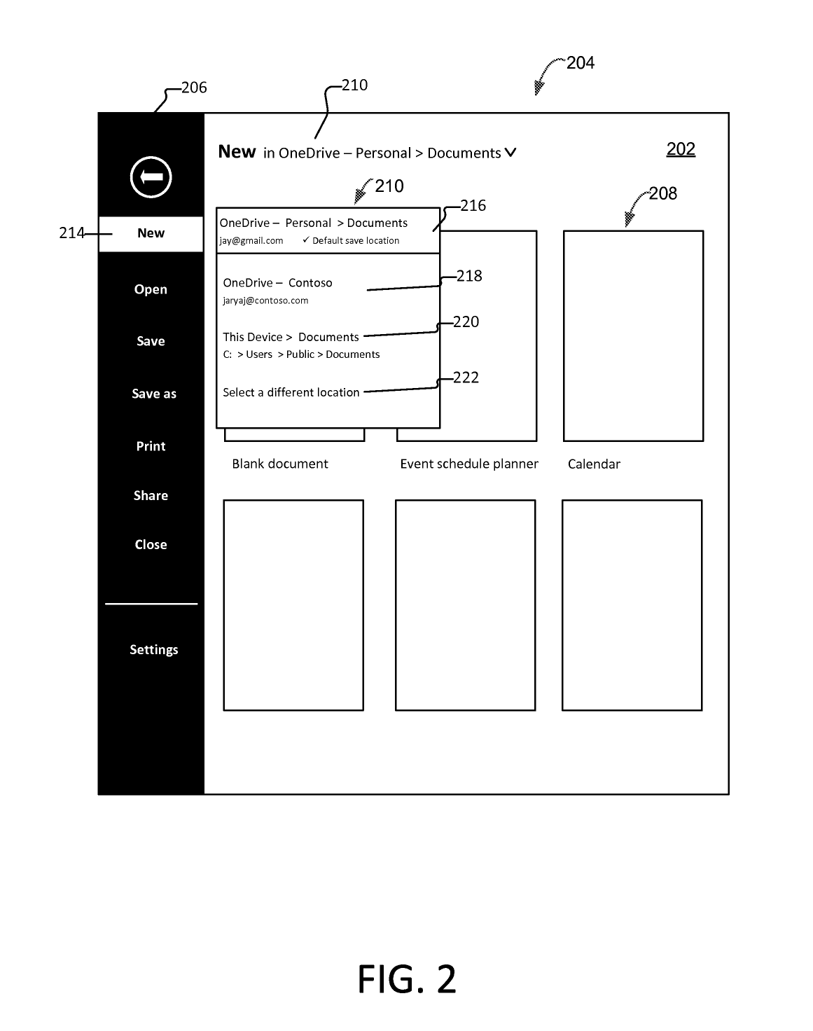

As discussed above, the system 100 may be configured to create at least one file associated with an application using a customizable list of storage locations. In one example, an application may include any application suitable for collaboration and/or co-authoring such as word processing applications, spreadsheet applications, electronic slide presentation applications, email applications, chat applications, voice applications, and the like. In one case, a file associated with the application may include a word document, a spreadsheet, an electronic slide presentation, an email, a chat conversation, and the like. As such, an exemplary application may be an electronic slide presentation application. In this example, an exemplary file associated with the electronic slide presentation application may include an electronic slide presentation. Storage locations may include local storage locations at the client computing device 104 and/or server locations at the server computing device 106. For example, a local storage location at the client computing device 104 may include the cache component 120. In another example, a server location at the server computing device 106 may include data store 160. In some cases, the customizable list of storage locations may include a generated list of storage locations. For example, the customizable list of storage locations may include predefined local storage locations and/or predefined server storage locations. In some aspects, the predefined local storage locations and the predefined server storage locations may be associated with one or more parameters, which will be described in more detail below relative to FIG. 2. In some cases, the customizable list of storage locations may include customized storage locations. The customized storage locations may include local storage locations and/or server storage locations. The customized storage locations may be based on a user preference and/or selection of storage locations, which will be described in more detail below relative to FIG. 2.

In aspects, the user interface component 110 may be in communication with the cache component 120. For example, when a new file associated with an application is selected for creation, the new file may be created to the cache component 120. In some examples, the cache component 120 may be a local cache. The cache component 120 may include CPU cache, disk cache, web cache, and the like. Before the new file is created to the cache component 120, the client disambiguation component 130 may determine whether any file name conflicts exist in the cache component 120. For example, the client disambiguation component 130 may be configured to review the files stored in the cache component 120 and create a new temporary file name for the new file that does not conflict with the files already existing in the cache component 120.

As discussed above, the server computing device 106 may provide data to and from the client computing device 104 through the network 105. In this regard, when a new file associated with an application is selected and created to the cache component 120, the new file may be automatically sent to the storage service 150 at the server computing device 106 in response to at least one trigger. In one example, the storage service 150 may be configured to store, manage, and access data and/or information associated with the system 100. For example, the storage service 150 may store one or more files in a data store 160. In one example, data store 160 may be part of and/or located at the storage service 150. In another example, data store 160 may be a separate component and/or may be located separate from the storage service 150. It is appreciated that although one server computing device 106 is illustrated in FIG. 1, the system 100 may include a plurality of server computing devices 106 with a plurality of storage services 150 and a plurality of data stores 160. In some cases, the server computing device 106 may include a plurality of storage services 150 and a plurality of data stores 160. In one example, the storage service 150 may be a cloud storage service such as OneDrive, SharePoint, Google Drive, Dropbox, and the like.

In aspects, a trigger includes at least one of editing the file, renaming the file, and sharing the file. In this regard, when a file is edited, renamed, and/or shared, the file is automatically sent to the storage service 150. As discussed above, a new file may be created in the cache component 120. In one example, a file is created when an application is launched and a file command for creating a new file is selected. In one example, the file command for creating a new file may include a “new” file command. As such, when the “new” file command is selected and received by the user interface component 110, a new file may be created in the cache component 120. When a new file is created, a file name may be automatically assigned to the created file. The server computing device 106 determines a name utilizing disambiguation logic that may be unique to each server computing device 106. In some examples, a file is edited when input is detected in the file. For example, an input may include typing, tapping, clicking, highlighting, deleting, and the like, within the file. In this regard, when an input is detected in the file, the file may be automatically sent to the storage service 150 and stored/created in the data store 160. In one example, a file is renamed when a rename option (e.g., a selectable control) is selected in association with an existing file to change the file name. In another example, a file is renamed by the server disambiguation component 140. For example, when a file is sent to the storage service 150, the server disambiguation component 140 may be consulted to determine whether a file name conflict exists at the storage service 150 and/or the data store 160. When a file name conflict exists, the server disambiguation component 140 may determine a unique file name and assign the unique file name to the file. When the unique file name is assigned to the file, the unique file name may be sent to the cache component 120. The cache component 120 may store a record of the received unique file name for the file. In this regard, when a file is renamed, the file may be automatically sent to the storage service 150 and/or created in the data store 160. In one example, a file is shared when a file command is selected. In one case, the file command may include a “share” file command. As such, when the “share” file command is selected and received by the user interface component 110, the file may be automatically sent to the storage service 150 and/or created in the data store 160. One of skill in the art will appreciate that other triggers may be used without departing from the spirit of this disclosure.

FIG. 2 illustrates an example touchable user interface 202 of the client computing device 104, such as a desktop computer, tablet computer or a mobile phone, for example, for creating at least one file associated with an application using a customizable list of storage locations, according to one or more aspects. In some examples, the touchable user interface 202 includes a canvas 204 and a contextual panel 206. The canvas 204 may include user interface elements 208 and a customizable list of storage locations 210. In some aspects, the canvas 204 and/or the contextual panel 206 is accessible or displayed after the selection of a general file command and/or an interface elements 208. In other aspects, the canvas 204 and/or contextual panel 206 is accessible or displayed on a start page running after the launch of an application. Generally, the user interface elements 208 refer to, for example, thumbnails, which represent a scaled down version of software applications and/or images such as documents, spreadsheets, presentation slides, and other objects. The contextual panel 206 may include file commands 214. For instance, such file commands may be general file commands such as “new,” “open,” “save,” “history,” “print,” “share,” “close,” and “settings.” The customizable list of storage locations 210, as illustrated in FIG. 2, includes a consumer account storage location 216, an enterprise account storage location 218, a local personal storage location 220, and a customize option 222.

The customizable list of storage locations 210 are exemplary storage locations of the customizable list of storage locations 210. It is appreciated that while FIG. 2 illustrates storage locations 216, 218, and 220, and customize option 222 of the customizable list of storage locations 210, the discussion of storage locations 216, 218, 220, and customize option 222 and the customizable list of storage locations 210 is exemplary only and should not be considered as limiting. Furthermore, while the present disclosure discusses the touchable user interface 202, canvas 204, contextual panel 206, user interface elements 208, and file commands 214 this is only exemplary and should not be considered limiting.

As discussed above, the customizable list of storage locations 210 may include a generated list of storage locations associated with one or more parameters. In one example, the one or more parameters used to generate the customizable list of storage locations 210 may include an account identifier associated with the application, a device type, a storage location frequency, and the like. The account identifier associated with the application may indicate the type of account used to access the application. For example, a user may login to an application using an account identifier that indicates a consumer account. In another example, a user may login to an application using an account identifier that indicates an enterprise account. In this regard, the customizable list of storage locations 210 generated based on the account identifier that indicates the consumer account may include storage locations associated with the consumer account. Similarly, the customizable list of storage locations 210 generated based on the account identifier that indicates the enterprise account may include storage locations associated with the enterprise account. The account identifier associated with the application may be an account identifier that indicates any type of account. For example, the type of account may include a consumer account, an enterprise account, a third party account, and the like.

In some cases, the device type may include any type of client computing device 104 as discussed herein. For example, the device type may include a mobile telephone, a smartphone, a tablet, a phablet, a smart watch, a wearable computer, a personal computer, a desktop computer, a laptop computer, a gaming device/computer (e.g., Xbox), a television, and etc. In other cases, the device type may include whether the device is a personal device or a company device, for example. In this regard, the customizable list of storage locations 210 generated based on the device type may include storage locations associated with the device type. For example, a smartphone may have a customizable list of storage locations associated with the smartphone. In another example, a tablet may have a customizable list of storage locations associated with the tablet device. In yet another example, a personal smartphone (e.g., a smartphone for personal use) may have a customizable list of storage locations associated with the personal smartphone. The examples described herein are exemplary only and should not be considered as limiting. A customizable list of storage locations may be generated for any device type.

In some cases, the storage location frequency may include a number of files created to a storage location. For example, the customizable list of storage locations 210 generated based on the account identifier may include five storage locations. A user of the system 100 associated with the account identifier may create a majority of files to three of the five storage locations. In this example, the storage location frequency is the number of files created to each of the five storage locations. In this regard, the customizable list of storage locations 210 may be generated based on the storage location frequency. For example, the generated customizable list may include a most recently used list of storage locations. Using the same example provided above, the customizable list of storage locations generated based on the storage location frequency may include the three storage locations of the five storage locations where a majority of the files are created.

As discussed above, the customizable list of storage locations 210 may be generated based on one or more parameters. In one aspect, the customizable list of storage locations 210 is generated based on at least two parameters. For example, the customizable list of storage locations 210 may be generated based on an account identifier and a device type. In one example, the account identifier may indicate a consumer account and the device type may be a personal device. In this regard, the customizable list of storage locations 210 generated based on the account identifier that indicates the consumer account and the personal device type may include storage locations associated with both the consumer account and the personal device type. In another example, the account identifier may indicate an enterprise account and the device type may be a personal device. In this case, the customizable list of storage locations generated based on the account identifier that indicates the enterprise account and the personal device type may include storage locations associated with both the enterprise account and the personal device type. The examples described herein are exemplary only and should not be considered as limiting. The customizable list of storage locations may be generated based on any combination of parameters and/or any number of parameters.

In some cases, the customizable list of storage locations 210 may be generated based on any number of the same type of parameters. For example, the customizable list of storage locations 210 may be generated based on at least two account identifiers. In one example, a first account identifier may indicate a consumer account and a second account identifier may indicate an enterprise account. In this regard, the customizable list of storage locations generated based on the first account identifier that indicates the consumer account and the second account identifier that indicates the enterprise account may include storage locations associated with both the consumer account and the enterprise account. The customizable list of storage locations 210, as illustrated in FIG. 2, includes storage locations associated with both the consumer account and the enterprise account. For example, the consumer account storage location 216 is listed as the first storage location in the customizable list of storage locations 210. The enterprise account storage location 218 is listed as the second storage location in the customizable list of storage locations 210.

In some cases, when the customizable list of storage locations 210 is generated based on more than one parameter, a conflict may exist between storage locations associated with the parameters. For example, a storage location associated with a first parameter may conflict with a storage location associated with a second parameter. In one example, the first parameter may be an account identifier indicating an enterprise account and the second parameter may be a device type indicating a personal device. The storage location associated with the enterprise account identifier may include an enterprise server storage location and the storage location associated with the personal device may include a local personal storage location. In this case, a conflict may exist between the enterprise server storage location and the local personal storage location. For example, when a user is using a personal device while logged-in to an enterprise account, the system 100 may generate the customizable list of storage locations 210 without the local personal storage location to prevent creation of a file associated with the enterprise account to the local personal storage location. In this regard, the customizable list of storage locations 210 may be generated without the local personal storage location even though the device type indicates a personal device. In another case, the customizable list of storage locations 210 may be generated with the local personal storage location but have the local personal storage location blocked out (not illustrated). In turn, the system 100 may prevent a secure file (e.g., a file associated with an enterprise account) from being created and stored on an insecure storage location such as a local personal storage location.

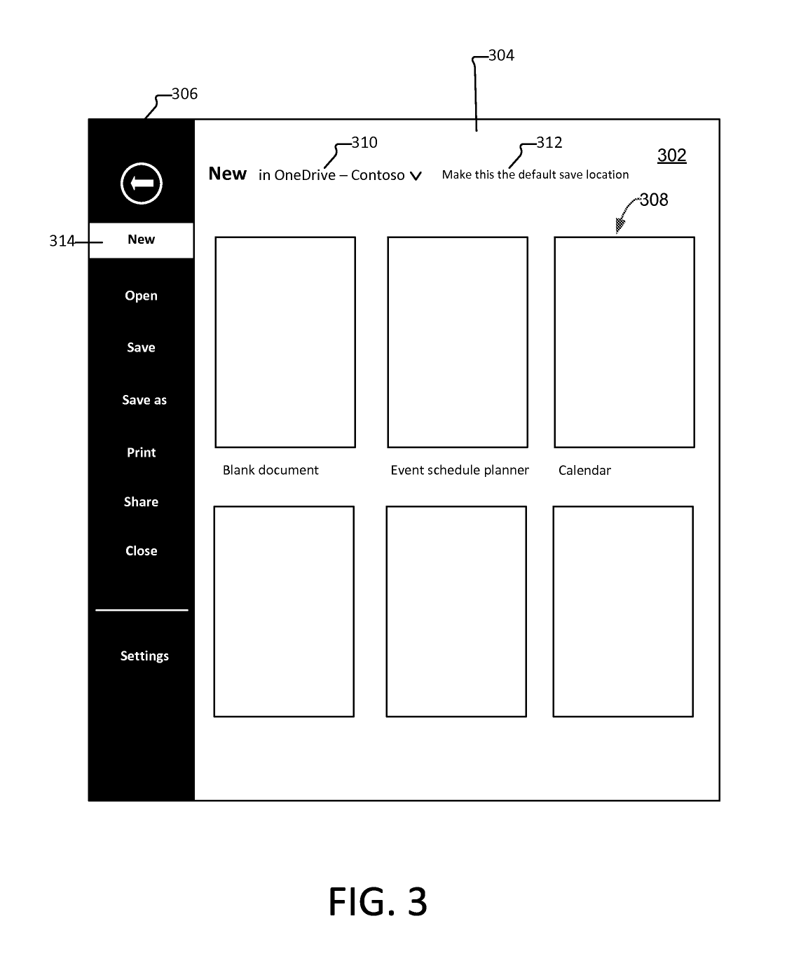

As discussed above, the customizable list of storage locations 210 may include customized storage locations. For example, the customizable list of storage locations 210 may include the customize option 222 for selecting a different location to customize the generated list of storage locations. In one case, when the customize option 222 is selected, an option for browsing local storage locations and/or server storage locations may be presented on the touchable user interface 202 (not illustrated). A local storage location or a server storage location may be selected based on a user preference and added to the customizable list of storage locations 210. In some cases, the local storage location or server location that is selected is added to the customizable list of storage locations 210 temporarily. For example, when a user navigates away from the touchable user interface 202, the added storage location may be removed. In other cases, the local storage location or server location that is selected is persisted when added to the customizable list of storage locations 210. In one example, the local storage location or server location that is selected is persisted when added to the customizable list of storage locations 210 permanently when a default location option is selected, which will be described in more detail below relative to FIG. 3. In some cases, the storage locations presented on the touchable user interface 202 for selection to customize the customizable list of storage locations 210 may be based on the one or more parameters for generating the customizable list of storage locations 210. For example, when the account identifier indicates a consumer account, the storage locations presented on the touchable user interface 202 for selection to customize the customizable list of storage locations 210 may only include consumer account storage locations. In this regard, the customizable list of storage locations 210 may not include enterprise account storage locations. In turn, the system 100 may prevent a file associated with a personal account from being created and stored on an enterprise account storage location. One of skill in the art will appreciate that the storage locations presented on the touchable user interface 202 for selection to customize the customizable list of storage locations 210 may be based on any of the one or more parameters without departing from the spirit of this disclosure.

As discussed above, in one example, the customizable list of storage locations 210 is ordered by most recently saved locations (e.g., the most recent locations to which files have been created). In some cases, the most recently saved locations may be based on any of the one or more parameters for generating the customizable list of storage locations 210. For example, the customizable list of storage locations 210 may be ordered based on the account identifier. In one case, when the account identifier indicates a consumer account the customizable list of storage locations 210 may be ordered by the most recently saved locations when a user is logged into the application with the consumer account. For example, if the last time a user logged-in to the application with the consumer account, a file was created in a personal folder, the personal folder may be the first location on the customizable list of storage locations 210. In another example, the customizable list of storage locations 210 may be ordered by most recently saved locations based on the account identifier and the device type. In yet another example, the customizable list of storage locations 210 may be ordered by most recently saved locations based on the account identifier, the device type, and the application that a user is logged-in to. In this regard, the system 100 may identify the type of application being used, the device type, and the account identifier and order the customizable list of storage locations 210 using the most recently saved locations associated with identify the type of application being used, the device type, and the account identifier. One of skill in the art will appreciate that the customizable list of storage locations 210 may be ordered by most recently saved locations based on any of the one or more parameters without departing from the spirit of this disclosure.

In some aspects, the customizable list of storage locations 210 may include a default save location. For example, when the customizable list of storage locations 210 is generated, one of the storage locations included in the customizable list of storage locations 210 may be set as the default save location. In this regard, when a new file is created and at least one trigger has been detected, the new file may be automatically sent to the default save location. In some cases, the default save location is identified with a checkmark and text such as, “Default save location,” as illustrated by the consumer account storage location 216 in FIG. 2. The default save location may initially be set based on the one or more parameters for generating the customizable list of storage locations 210. For example, the default save location may be set based on the account identifier. In one case, when the account identifier indicates a consumer account, the default save location may be set to OneDrive personal documents folder, as illustrated by consumer account storage location 216 in FIG. 2. In another case, when the account identifier indicates an enterprise account, the default save location may be set to a SharePoint OneDrive for Business root folder. In yet another case, when a first account identifier indicates a consumer account and a second account identifier indicates an enterprise account (e.g., a user is logged-in to an application using both the consumer account and the enterprise account), the default save location may be set to SharePoint OneDrive for Business root folder. In this regard, the default save location limits the likelihood of personal files being created in a more secure enterprise storage location and secure enterprise files being created in a more non-secure personal storage location.

FIG. 3 illustrates an example touchable user interface 302 of the client computing device 104, such as a desktop computer, tablet computer or a mobile phone, for example, for creating at least one file associated with an application using a customizable list of storage locations, according to one or more aspects. In some examples, the touchable user interface 302 includes a canvas 304 and a contextual panel 306. The canvas 304 may include user interface elements 308, a customizable list of storage locations 310, and a default location option 312. The contextual panel 306 may include file commands 314. The touchable user interface 302 including canvas 304, contextual panel 306, user interface elements 308, the customizable list of storage locations 310, and file commands 314 may be configured similar to the touchable user interface 202, canvas 204, contextual panel 206, user interface elements 208, the customizable list of storage locations 210, and file commands 214 described above relative to FIG. 2. In this regard, the touchable user interface 302 may include all the functionality described in the above aspects relative to the touchable user interface 202 of FIG. 2.

In some examples, the default save location may be selected based on a user preference. In this regard, when a selection of a new storage location on the customizable list of storage locations 310 is received, the default location option 312 may be displayed on the touchable user interface 302. When the default location option 312 is selected, the new storage location that has been selected will be set as the default save location. The default save location setting will be preserved until the default location option 312 is selected for a new storage location. For example, a file may be created to a storage location other than the default save location by selecting a storage location from the customizable list of storage locations 310, as described above. In this case, the selected storage location is temporary and will not be set as the default save location. As such, the next time a file is created, the file will be automatically created to the default save location, unless a different storage location is selected.

In aspects, the default location option 312 is only displayed and visible on the touchable user interface 302 when the selection of the customizable list of storage locations 310 changes. As such, as described above, when a selection of a new storage location on the customizable list of storage locations 310 is received, the default location option 312 may be displayed on the touchable user interface 302. As illustrated in FIG. 3, the customizable list of storage locations 310 may be collapsed. In one example, the customizable list of storage locations 310 is collapsed by default and expanded when selected. In this regard, when a new file is created, the customizable list of storage locations 310 is collapsed initially on the touchable user interface 302, as shown in FIG. 3. The collapsed customizable list of storage locations 310 may be expanded to show the list of storage locations (as described above relative to FIG. 2) when the collapsed customizable list of storage locations 310 is selected. In one case, as illustrated in FIGS. 2 and 3, an arrow associated with the customizable list of storage locations 210/310 may be selected to expand and collapse the customizable list of storage locations 210/310.

In some cases, when a new file is created to a storage location, the new file may be shared with one or more users of the application. In one example, when the new file is created to a storage location, as described herein, the touchable user interface 202/302 may display a sharing option (not illustrated). In some aspects, the sharing option may include a list of one or more users of the application. The one or more users in the sharing option list may be selected for sharing the new file. In one case, the one or more users included in the sharing option list may be based on the one or more parameters for generating the customizable list of storage locations 210/310. For example, when the account identifier indicates an enterprise account, the sharing option list may include users of the application who have been collaborated with when the account identifier indicates the enterprise account. In another example, when the account identifier indicates an enterprise account, the sharing option list may include users of the application who also have enterprise accounts. In yet another example, the one or more users included in the sharing option list may be based on the account identifier and the storage location where the file is created. In this regard, sharing privileges may be auto-generated on the new file during creation of the new file.

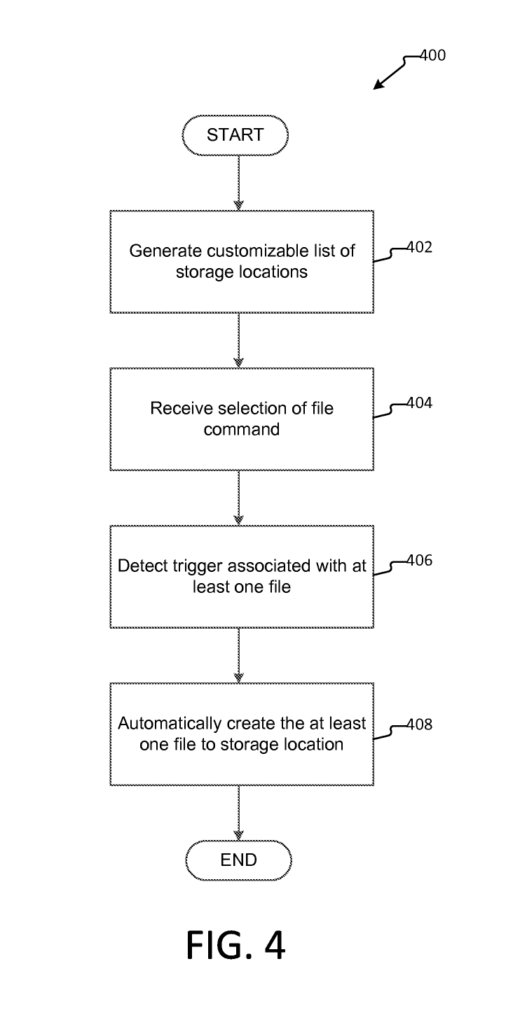

Referring now to FIG. 4, an exemplary method 400 for creating at least one file associated with an application using a customizable list of storage locations, according to an example aspect is shown. Method 400 may be implemented on a computing device or a similar electronic device capable of executing instructions through at least one processor. The at least one file may be created by any suitable software application. For example, the software application may be one of an email application, a social networking application, project management application, a collaboration application, an enterprise management application, a messaging application, a word processing application, a spreadsheet application, a database application, a presentation application, a contacts application, a calendaring application, and etc. This list is exemplary only and should not be considered as limiting. Any suitable application for creating at least one file may be utilized by method 400.

Method 400 may begin at operation 402, where a customizable list of storage locations is generated. In one case, the customizable list of storage locations is expandable and collapsible. In one example, the customizable list of storage locations may include predefined local storage locations and/or predefined server storage locations. In some aspects, the predefined local storage locations and the predefined server storage locations may be associated with one or more parameters. The one or more parameters associated with the application may include at least an account identifier, a device type, and a storage location frequency. The account identifier indicates a type of account used to access the application. In some cases, the customizable list of storage locations may include customized local storage locations and/or customized server storage locations. The customized storage locations may be based on a user preference and/or selection of storage locations.

When a customizable list of storage locations is generated, flow may proceed to operation 404, where a selection of a file command for creating the at least one file associated with the application is received within the application. The file commands for creating the at least one file associated with the application are accessible via a canvas and/or a contextual panel. In some aspects, the canvas and/or the contextual panel may be accessible or displayed after the selection of a general file command in an application and/or after selection of an interface element. In other aspects, the canvas 204 and/or contextual panel 206 is accessible or displayed on a start page running after the launch of an application, such as Microsoft Office™. In aspects, a file command may be a general file command such as “new,” “open,” “save,” “history,” “print,” “share,” “close,” and “settings.” In one example, the file command for creating a new file may include a “new” file command As such, when the “new” file command is selected and received by a user interface component, a new file may be initially created in a cache component. When a new file is created, a file name may be automatically assigned to the created file.

When a selection of a file command for creating the at least one file associated with the application is received within the application, flow may proceed to operation 406, where a trigger associated with the at least one file is detected. In one example, a trigger includes at least one of editing the at least one file, renaming the at least one file, and sharing the least one file. In some examples, a file is edited when input is detected in the file. For example, an input may include typing, tapping, clicking, highlighting, deleting, and the like, within the file. In this regard, when an input is detected in the file, the file may be automatically sent to the storage service and stored/created in the data store. In one example, a file is renamed when a rename option (e.g., a selectable control) is selected in association with an existing file to change the file name. In another example, a file is renamed by the server disambiguation component. For example, when a file is sent to the storage service, the server disambiguation component may be consulted to determine whether a file name conflict exists at the storage service and/or the data store. When a file name conflict exists, the server disambiguation component may determine a unique file name and assign the unique file name to the file. When the unique file name is assigned to the file, the unique file name may be sent to the cache component. The cache component may store a record of the received unique file name for the file. In this regard, when a file is renamed, the file may be automatically sent to the storage service and/or created in the data store. In one example, a file is shared when a file command is selected. In one case, the file command may include a “share” file command. As such, when the “share” file command is selected and received by the user interface component, the file may be automatically sent to the storage service and/or created in the data store.

In response to detecting a trigger associated with the at least one file, flow proceeds to operation 408, where the at least one file is automatically created to a storage location from the customizable list of storage locations. In this regard, when a file is edited, renamed, and/or shared, the file is automatically created to a storage location from the customizable list of storage locations. The storage locations may include predefined local storage locations and/or predefined server storage locations. In some aspects, the predefined local storage locations and the predefined server storage locations may be associated with one or more parameters. In some cases, the customizable list of storage locations may include customized local storage locations and/or customized server storage locations. The customized storage locations may be based on a user preference and/or selection of storage locations. In one case, when a file is edited, renamed, and/or shared, the file is automatically sent to the storage service. In one example, a new file may be created in the cache component. In another example, a new file may be created in a default storage location. In one example, when a new file is created, a file name may be automatically assigned to the created file.

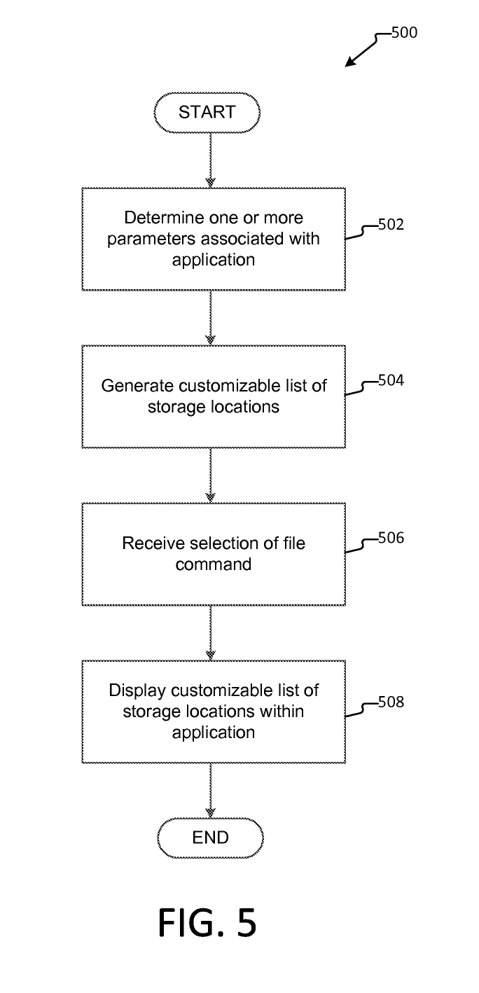

Referring now to FIG. 5, an exemplary method 500 for providing a customizable list of storage locations, according to an example aspect is shown. Method 500 begins at operation 502 where one or more parameters associated with an application are determined The one or more determined parameters may include an account identifier associated with the application, a device type, a storage location frequency, and the like. The account identifier associated with the application may indicate the type of account used to access the application. For example, a user may login to an application using an account identifier that indicates a consumer account. In some cases, the device type may include any type of client computing device such as a mobile telephone, a smartphone, a tablet, a phablet, a smart watch, a wearable computer, a personal computer, a desktop computer, a laptop computer, a gaming device/computer (e.g., Xbox), a television, and etc. In other cases, the device type may include whether the device is a personal device or a company device, for example. In this regard, the customizable list of storage locations generated based on the device type may include storage locations associated with the device type. In some cases, the storage location frequency may include a number of files created to a storage location. For example, the customizable list of storage locations generated based on the account identifier may include four storage locations. A user of an application associated with the account identifier may create a majority of files to two of the four storage locations. In this example, the storage location frequency is the number of files created to each of the four storage locations.

When one or more parameters associated with an application are determined, flow proceeds to operation 504 where a customizable list of storage locations is generated. In one case, the customizable list of storage locations is expandable and collapsible. In one example, the customizable list of storage locations may include predefined local storage locations and/or predefined server storage locations. In some aspects, the predefined local storage locations and the predefined server storage locations may be associated with one or more parameters. The one or more parameters associated with the application may include at least an account identifier, a device type, and a storage location frequency. The account identifier indicates a type of account used to access the application. In some cases, the customizable list of storage locations may include customized local storage locations and/or customized server storage locations. The customized storage locations may be based on a user preference and/or selection of storage locations.

At operation 506, a selection of a file command for creating the at least one file associated with the application is received within the application. In aspects, such file commands may be general file commands such as “new,” “open,” “save,” “history,” “print,” “share,” “close,” and “settings.” In one example, the file command for creating a new file may include a “new” file command. As such, when the “new” file command is selected and received by a user interface component, a new file may be initially created in a cache component. When a new file is created, a file name may be automatically assigned to the created file.

In response to receiving the selection of the file command, flow proceeds to operation 508, where the customizable list of storage locations is displayed within the application. In one case, the customizable list of storage locations is expandable and collapsible. The customizable list of storage locations may include a consumer account storage location, an enterprise account storage location, and a local personal storage location. In one example, the customizable list of storage locations may include predefined local storage locations and/or predefined server storage locations. In some cases, the customizable list of storage locations may include customized local storage locations and/or customized server storage locations. The customized storage locations may be based on a user preference and/or selection of storage locations. For example, the customizable list of storage locations may include a customize option for selecting a different location to customize the generated list of storage locations.

Techniques for creating at least one file associated with an application using a customizable list of storage locations are described. Although aspects are described in language specific to structural features and/or methodological acts, it is to be understood that the aspects defined in the appended claims are not necessarily limited to the specific features or acts described above. Rather, the specific features and acts are disclosed as example forms of implementing the claimed aspects.

A number of methods may be implemented to perform the techniques discussed herein. Aspects of the methods may be implemented in hardware, firmware, or software, or a combination thereof. The methods are shown as a set of blocks that specify operations performed by one or more devices and are not necessarily limited to the orders shown for performing the operations by the respective blocks. Further, an operation shown with respect to a particular method may be combined and/or interchanged with an operation of a different method in accordance with one or more implementations. Aspects of the methods may be implemented via interaction between various entities discussed above with reference to the touchable user interface.

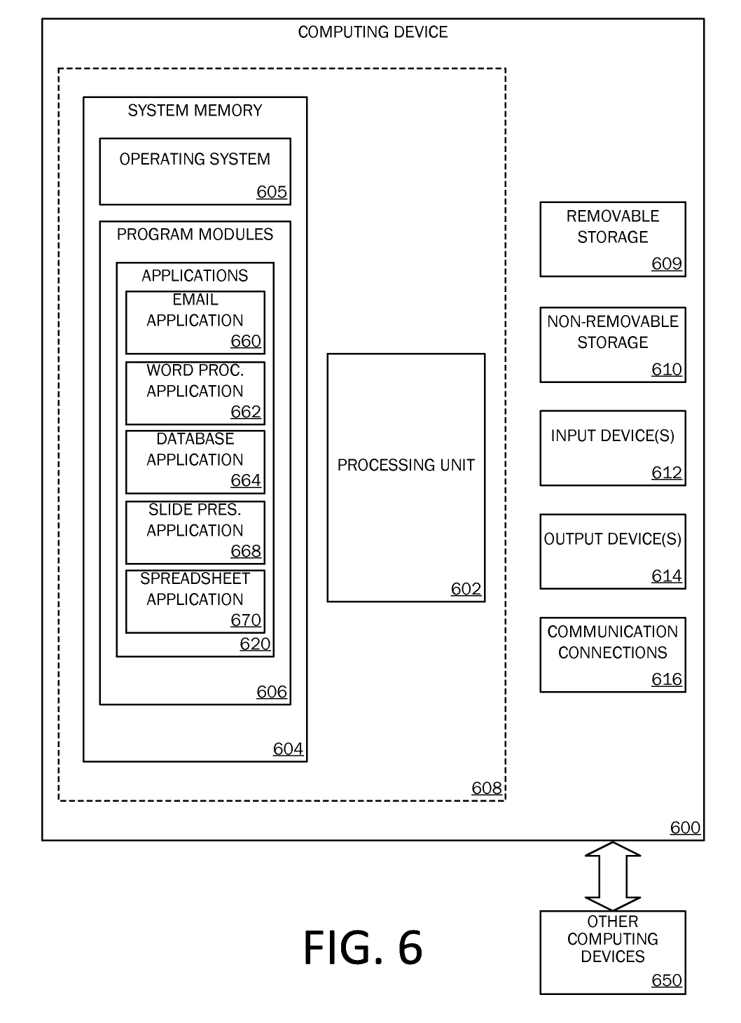

FIGS. 6-8 and the associated descriptions provide a discussion of a variety of operating environments in which aspects of the disclosure may be practiced. However, the devices and systems illustrated and discussed with respect to FIGS. 6-8 are for purposes of example and illustration and are not limiting of a vast number of computing device configurations that may be utilized for practicing aspects of the disclosure, described herein

FIG. 6 is a block diagram illustrating physical components (e.g., hardware) of a computing device 600 with which aspects of the disclosure may be practiced. The computing device components described below may be computer executable instructions for an email application 660, word processing application 662, database application 664, slide presentation application 668, spreadsheet application 670, and any other suitable application that can be executed to employ the methods 400 and 500 disclosed herein. The computing device components described below may further be computer executable instructions for the storage service 150, for example. In a basic configuration, the computing device 600 may include at least one processing unit 602 and a system memory 604. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 620 utilizing the system as illustrated in FIGS. 1-3. The operating system 605, for example, may be suitable for controlling the operation of the computing device 600. Furthermore, aspects of the disclosure may be practiced in conjunction with a graphics library, other operating systems, or any other application program and is not limited to any particular application or system. This basic configuration is illustrated in FIG. 6 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 6 by a removable storage device 609 and a non-removable storage device 610.

As stated above, a number of program modules and data files may be stored in the system memory 604. While executing on the processing unit 602, the program modules 606 may perform processes including, but not limited to, the aspects, as described herein. Other program modules that may be used in accordance with aspects of the present disclosure, and in particular to generate screen content, may include electronic mail and contacts applications, contact applications, drawing applications, messaging applications, calendaring applications, a social networking application, project management application, a collaboration application, an enterprise management application, and/or etc.

Furthermore, aspects of the disclosure may be practiced in an electrical circuit comprising discrete electronic elements, packaged or integrated electronic chips containing logic gates, a circuit utilizing a microprocessor, or on a single chip containing electronic elements or microprocessors. For example, aspects of the disclosure may be practiced via a system-on-a-chip (SOC) where each or many of the components illustrated in FIG. 6 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to the capability of client to switch protocols may be operated via application-specific logic integrated with other components of the computing device 600 on the single integrated circuit (chip). Aspects of the disclosure may also be practiced using other technologies capable of performing logical operations such as, for example, AND, OR, and NOT, including but not limited to mechanical, optical, fluidic, and quantum technologies. In addition, aspects of the disclosure may be practiced within a general purpose computer or in any other circuits or systems.

The computing device 600 may also have one or more input device(s) 612 such as a keyboard, a mouse, a pen, a sound or voice input device, a touch or swipe input device, etc. The output device(s) 614 such as a display, speakers, a printer, etc. may also be included. The aforementioned devices are examples and others may be used. The computing device 600 may include one or more communication connections 616 allowing communications with other computing devices 650. Examples of suitable communication connections 616 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (e.g., memory storage) Computer storage media may include RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media does not include a carrier wave or other propagated or modulated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media.

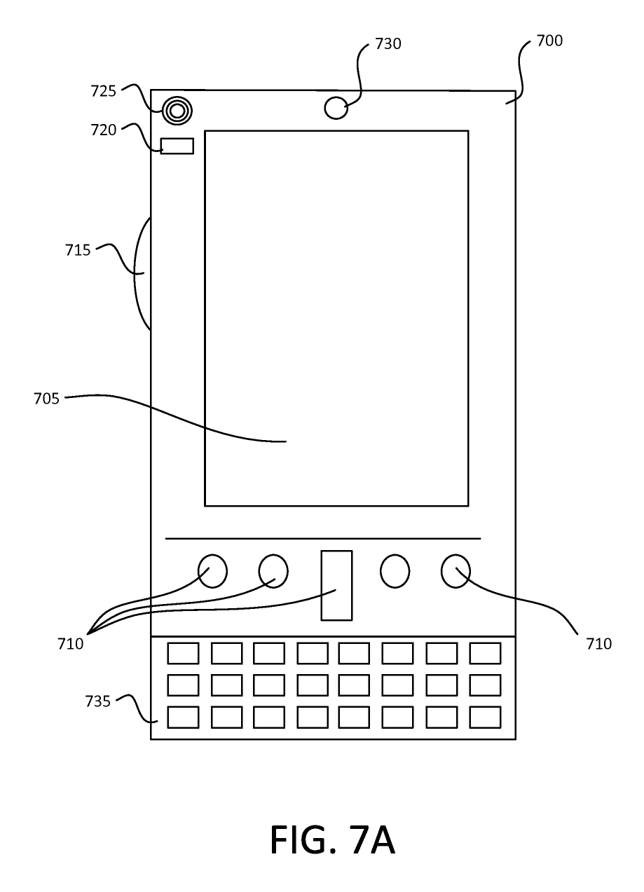

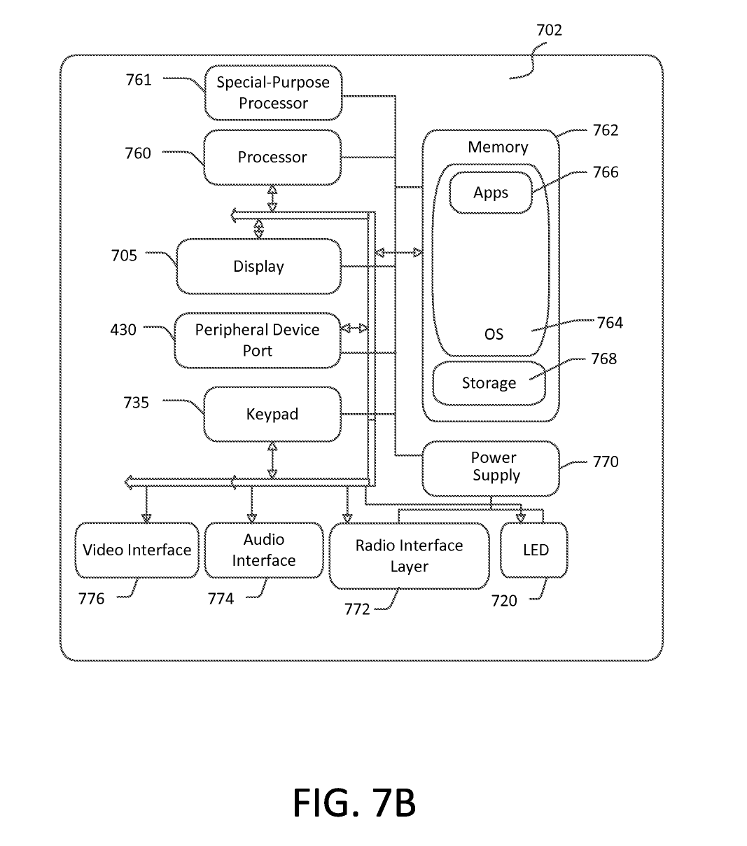

FIGS. 7A and 7B illustrate a mobile computing device 700, for example, a mobile telephone, a smart phone, wearable computer (such as a smart watch), a tablet personal computer, a laptop computer, a desktop computer, and the like, with which aspects of the disclosure may be practiced. In some aspects, the client may be a mobile computing device. With reference to FIG. 7A, one aspect of a mobile computing device 700 for implementing the aspects is illustrated. In a basic configuration, the mobile computing device 700 is a handheld computer having both input elements and output elements. The mobile computing device 700 typically includes a display 705 and one or more input buttons 710 that allow the user to enter information into the mobile computing device 700. The display 705 of the mobile computing device 700 may also function as an input device (e.g., a touch screen display). If included, an optional side input element 715 allows further user input. The side input element 715 may be a rotary switch, a button, or any other type of manual input element. In alternative aspects, mobile computing device 700 may incorporate more or less input elements. For example, the display 705 may not be a touchpad in some aspects. In yet another alternative aspect, the mobile computing device 700 is a portable phone system, such as a cellular phone. The mobile computing device 700 may also include an optional keypad 735. Optional keypad 735 may be a physical keypad or a “soft” keypad generated on the touch screen display. In various aspects, the output elements include the display 705 for showing a graphical user interface (GUI), a visual indicator 720 (e.g., a light emitting diode), and/or an audio transducer 725 (e.g., a speaker). In some aspects, the mobile computing device 700 incorporates a vibration transducer for providing the user with tactile feedback. In yet another aspect, the mobile computing device 700 incorporates input and/or output ports, such as an audio input (e.g., a microphone jack), an audio output (e.g., a headphone jack), and a video output (e.g., a HDMI port) for sending signals to or receiving signals from an external device.

FIG.7B is a block diagram illustrating the architecture of one aspect of a mobile computing device. That is, the mobile computing device 700 can incorporate a system (e.g., an architecture) 702 to implement some aspects. In one aspect, the system 702 is implemented as a “smart phone” capable of running one or more applications (e.g., browser, e-mail, calendaring, contact managers, messaging clients, games, and media clients/players). In some aspects, the system 702 is integrated as a computing device, such as an integrated personal digital assistant (PDA) and wireless phone.

One or more application programs 766 may be loaded into the memory 762 and run on or in association with the operating system 764. Examples of the application programs include phone dialer programs, e-mail programs, personal information management (PIM) programs, word processing programs, spreadsheet programs, Internet browser programs, messaging programs, and so forth. The system 702 also includes a non-volatile storage area 768 within the memory 762. The non-volatile storage area 768 may be used to store persistent information that should not be lost if the system 702 is powered down. The application programs 766 may use and store information in the non-volatile storage area 768, such as e-mail or other messages used by an e-mail application, and the like. A synchronization application (not shown) also resides on the system 702 and is programmed to interact with a corresponding synchronization application resident on a host computer to keep the information stored in the non-volatile storage area 768 synchronized with corresponding information stored at the host computer. As should be appreciated, other applications may be loaded into the memory 762 and run on the mobile computing device 700, including the instructions to merge and display file history data as described herein.

The system 702 has a power supply 770, which may be implemented as one or more batteries. The power supply 770 might further include an external power source, such as an AC adapter or a powered docking cradle that supplements or recharges the batteries.

The system 702 may also include a radio 772 that performs the function of transmitting and receiving radio frequency communications. The radio 772 facilitates wireless connectivity between the system 702 and the “outside world,” via a communications carrier or service provider. Transmissions to and from the radio 772 are conducted under control of the operating system 764. In other words, communications received by the radio 772 may be disseminated to the application programs 766 via the operating system 764, and vice versa.

The visual indicator 720 may be used to provide visual notifications, and/or an audio interface 774 may be used for producing audible notifications via the audio transducer 725. In the illustrated aspect, the visual indicator 720 is a light emitting diode (LED) and the audio transducer 725 is a speaker. These devices may be directly coupled to the power supply 770 so that when activated, they remain on for a duration dictated by the notification mechanism even though the processor 760 and other components might shut down for conserving battery power. The LED may be programmed to remain on indefinitely until the user takes action to indicate the powered-on status of the device. The audio interface 774 is used to provide audible signals to and receive audible signals from the user. For example, in addition to being coupled to the audio transducer 725, the audio interface 774 may also be coupled to a microphone to receive audible input, such as to facilitate a telephone conversation. In accordance with aspects of the present disclosure, the microphone may also serve as an audio sensor to facilitate control of notifications, as will be described below. The system 702 may further include a video interface 776 that enables an operation of an on-board camera 730 to record still images, video stream, and the like.

A mobile computing device 700 implementing the system 702 may have additional features or functionality. For example, the mobile computing device 700 may also include additional data storage devices (removable and/or non-removable) such as, magnetic disks, optical disks, or tape. Such additional storage is illustrated in FIG. 7B by the non-volatile storage area 768.

Data/information generated or captured by the mobile computing device 700 and stored via the system 702 may be stored locally on the mobile computing device 700, as described above, or the data may be stored on any number of storage media that may be accessed by the device via the radio 772 or via a wired connection between the mobile computing device 700 and a separate computing device associated with the mobile computing device 700, for example, a server computer in a distributed computing network, such as the Internet. As should be appreciated such data/information may be accessed via the mobile computing device 700 via the radio 772 or via a distributed computing network. Similarly, such data/information may be readily transferred between computing devices for storage and use according to well-known data/information transfer and storage means, including electronic mail and collaborative data/information sharing systems.

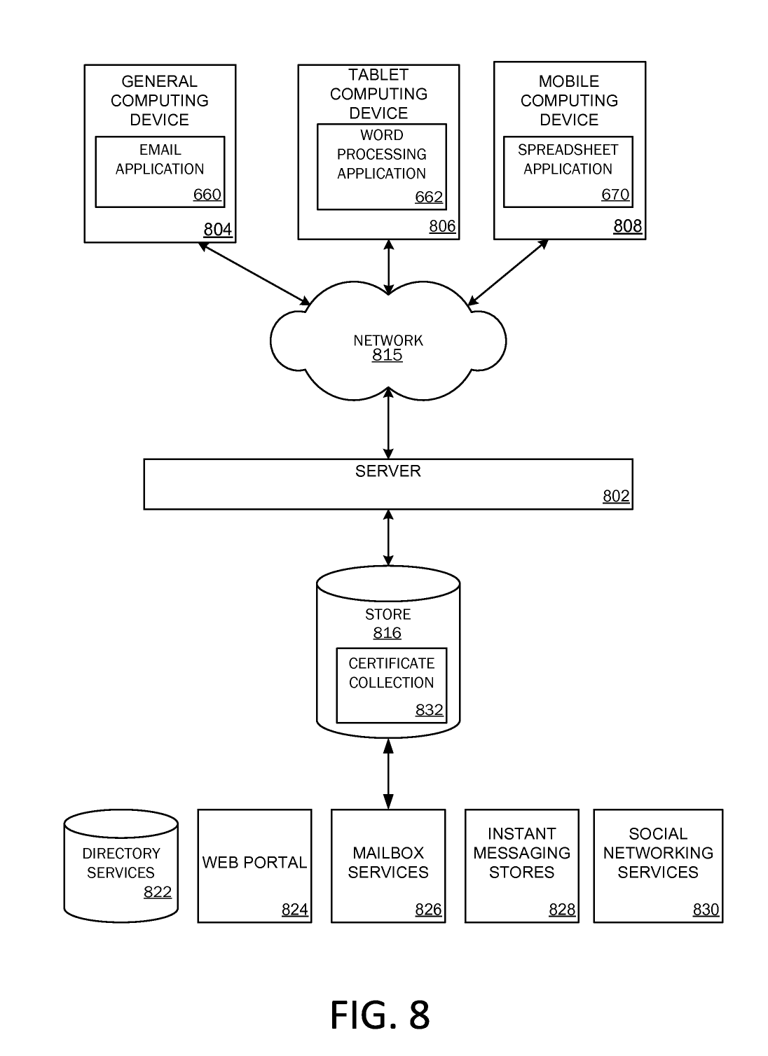

FIG. 8 illustrates one aspect of the architecture of a system for processing data received at a computing system from a remote source, such as a computing device 804, tablet 806, or mobile device 808, as described above. Content displayed at server device 802 may be stored in different communication channels or other storage types. In this aspect, the general computing device 804 is executing an email application 660 that is part of the system described herein. Further, in this aspect, the tablet 806 is executing a word processing application 662 that is part of the system described herein. Additionally, in this aspect, the mobile computing device 808 is executing a spreadsheet application that is part of the system described herein. Systems and methods for creating at least one file associated with an application using a customizable list of storage locations are described in detail above and illustrated in FIGS. 1-3. For example, various documents may be stored using a directory service 822, a web portal 824, a mailbox service 826, an instant messaging store 828, or a social networking site 830.

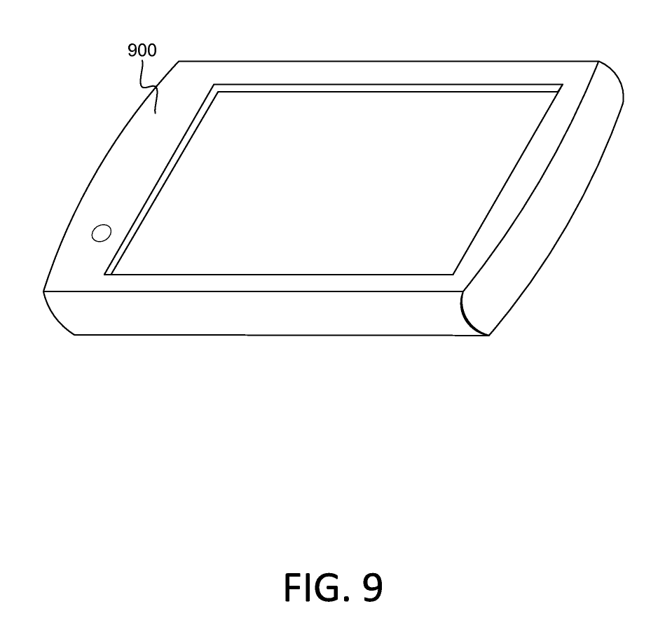

FIG. 9 illustrates an exemplary tablet computing device 900 that may execute one or more aspects disclosed herein. In addition, the aspects and functionalities described herein may operate over distributed systems (e.g., cloud-based computing systems), where application functionality, memory, data storage and retrieval and various processing functions may be operated remotely from each other over a distributed computing network, such as the Internet or an intranet. User interfaces and information of various types may be displayed via on-board computing device displays or via remote display units associated with one or more computing devices. For example user interfaces and information of various types may be displayed and interacted with on a wall surface onto which user interfaces and information of various types are projected. Interaction with the multitude of computing systems with which aspects of the invention may be practiced include, keystroke entry, touch screen entry, voice or other audio entry, gesture entry where an associated computing device is equipped with detection (e.g., camera) functionality for capturing and interpreting user gestures for controlling the functionality of the computing device, and the like.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of claimed disclosure. The claimed disclosure should not be construed as being limited to any aspect, example, or detail provided in this application. Regardless of whether shown and described in combination or separately, the various features (both structural and methodological) are intended to be selectively included or omitted to produce an aspect with a particular set of features. Having been provided with the description and illustration of the present application, one skilled in the art may envision variations, modifications, and alternate aspects falling within the spirit of the broader aspects of the general inventive concept embodied in this application that do not depart from the broader scope of the claimed disclosure.

Additionally, while the aspects may be described in the general context of file history systems that execute in conjunction with an application program that runs on an operating system on a computing device, those skilled in the art will recognize that aspects may also be implemented in combination with other program modules. In further aspects, the aspects disclosed herein may be implemented in hardware.

Generally, program modules include routines, programs, components, data structures, and other types of structures that perform particular tasks or implement particular abstract data types. Moreover, those skilled in the art will appreciate that aspects may be practiced with other computer system configurations, including hand-held devices, multiprocessor systems, microprocessor-based or programmable consumer electronics, minicomputers, mainframe computers, and comparable computing devices. Aspects may also be practiced in distributed computing environments where tasks are performed by remote processing devices that are linked through a communications network. In a distributed computing environment, program modules may be located in both local and remote memory storage devices.

Aspects may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium can for example be implemented via one or more of a volatile computer memory, a non-volatile memory, a hard drive, a flash drive, a floppy disk, or compact servers, an application executed on a single computing device, and comparable systems.

What is claimed is:

1. A system comprising:
at least one processor; and
memory encoding computer executable instructions that, when executed by the at least one processor, cause the at least one processor to perform a method for creating at least one file associated with an application using a customizable list of storage locations, the method comprising:
generating the customizable list of storage locations based on one or more parameters associated with the application;
receiving, within the application, a selection of a file command for creating the at least one file associated with the application;
detecting a trigger associated with the at least one file;
in response to detecting the trigger associated with the at least one file, automatically creating the at least one file to a storage location from the customizable list of storage locations.

2. The system of claim 1, wherein the customizable list of storage locations is expandable and collapsible.

3. The system of claim 1, wherein the one or more parameters associated with the application include at least an account identifier, a device type, and a storage location frequency.

4. The system of claim 3, wherein the account identifier indicates a type of account used to access the application.

5. The system of claim 1, wherein the trigger includes at least one of editing the at least one file, renaming the at least one file, and sharing the at least one file.

6. The system of claim 1, wherein the customizable list of storage locations includes at least one of predefined local storage locations and predefined server storage locations.

7. The system of claim 1, wherein the customizable list of storage locations includes at least one of customized local storage locations and customized server storage locations.

8. The system of claim 1, further comprising automatically assigning a name to the at least one created file.

9. The system of claim 1, wherein the file command is a new file command.

10. The system of claim 1, further comprising in response to receiving the selection of the file command, displaying the customizable list of storage locations within the application.

11. The system of claim 1, further comprising setting a storage location from the customizable list of storage locations as a default storage location.

12. A system comprising:
at least one processor; and
memory encoding computer executable instructions that, when executed by the at least one processor, cause the at least one processor to perform a method for providing a customizable list of storage locations, the method comprising:
determining one or more parameters associated with an application;
generating the customizable list of storage locations based on the one or more parameters associated with the application;
receiving, within the application, a selection of a file command for creating at least one file associated with the application; and
in response to receiving the selection of the file command, displaying the customizable list of storage locations within the application.

13. The system of claim 12, wherein the customizable list of storage locations includes a default storage location.

14. The system of claim 12, further comprising detecting a trigger associated with the at least one file.

15. The system of claim 14, further comprising in response to detecting the trigger associated with the at least one file, automatically creating the at least one file to a storage location from the customizable list of storage locations.

16. The system of claim 12, wherein the one or more parameters associated with the application include at least an account identifier, a device type, and a storage location frequency.

17. The system of claim 12, wherein the trigger includes at least one of editing the at least one file, renaming the at least one file, and sharing the at least one file.

18. A method for creating at least one file associated with an application using a customizable list of storage locations including at least one processor, and memory encoding computer executable instructions that, when executed by at least one processor, cause the at least one processor to perform the method, the method comprising:
determining one or more parameters associated with an application;
generating the customizable list of storage locations based on the one or more parameters associated with the application;
setting a storage location from the customizable list of storage locations as a default storage location;
detecting a trigger associated with at least one file associated with the application;
in response to detecting the trigger associated with the at least one file, automatically creating the at least one file to the default storage location.

19. The method of claim 18, further comprising receiving, within the application, a selection of a file command for creating at least one file associated with the application.

20. The method of claim 19, further comprising in response to receiving the selection of the file command, displaying the customizable list of storage locations within the application.
